(19) United States
(12) Patent Application Publication
(10) Pub. No.: US 2018/0068108 A1
(43) Pub. Date: Mar. 8, 2018

(54) A MOBILE DEVICE AND SYSTEMS TO SECURELY REMOTELY ACCESS, MANAGE AND STORE AN ENTERPRISE'S DATA, USING EMPLOYEES SMART ADD-ONs AND MOBILE DEVICES

(71) Applicant: OS-NEW HORIZONS PERSONAL COMPUTING SOLUTIONS LTD., Lod (IL)

(72) Inventors: Gila FISH, Mevasseret Zion (IL); Avner KORMAN, Herzlia (IL); David Mor OFEK, Nes Harim (IL); Alex GERDOV, Bene Aysh (IL); Yevgeni MISHUSTIN, Bet Shemesh (IL)

(21) Appl. No.: 15/551,913

(22) PCT Filed: Feb. 18, 2016
(86) PCT No.: PCT/IB16/50874

§ 371 Date: Sep. 18, 2017

Related U.S. Application Data
(60) Provisional application No. 62/117,463, filed on Feb. 18, 2015.

(51) Int. Cl. G06F 21/44; G06F 21/32; H05K 5/02; G06F 21/71

(52) U.S. Cl. CPC G06F 21/445; G06F 21/71; H05K 5/0247; G06F 21/32

(57) ABSTRACT

A mobile device, a method and system are providing the invention mobile Bring Your Own Device (BYOD) enhanced security management platform solution. The platform enables users to securely access the secured enterprise data and its IT management, through the employees/users invention personal mobile device. Thus enabling the employee secure access to enterprise proprietary data for work related data management, updating and storage, all on the employee/user's mobile hardware device. It is combined with blocking none-legitimate user's access to the invention devices secured storage content and to the employers IT resources. The invention mobile device employee authentication and following employers' data access, is based on the combined output of at least two different human biological/physiological sensors fusion and their weighted combined output analysis, executed internally within the device signal processing firmware. Under authentication success it activates various employer's work applications, while employee operating and freely using private data resources and services.

### FIELD OF THE INVENTION

The present invention relates to BYOD (Bring Your Own Device) dedicated hybrid employee-employer managed mobile electronic devices and systems, serving the private users who are employed by an enterprise, with an advanced new approach dedicated for creating isolated secured data exchange and communication capabilities between the user/employee through his security enhanced mobile device and his employer enterprise IT resources, The invention relates also to enabling the execution of a mandatory personal and a highly secured preliminary legitimate user's authentication stage. The invention relates in particular to the need of integration to conventional mobile communication devices with add-on based computerized authentication and secured data management and storage devices, and their operational method.

The field of the invention also relates to new ways of supporting the user's authentication, while blocking the access of any non-legitimate user to the user's employer secured data resources depository residing on the user's mobile device. The Invention relates also to the needs of supporting the user's and the employer's needs for a secured and reliable mutual data exchange capability and for consistently securely updating and managing a user's privately owned device with the enterprise relevant parts of the employee tasks related data depository. The sensitive enterprise related data may be residing on the mobile device, or within the remote enterprise IT management and storage resources, or both. In addition the invention also deals to highly secured supporting data management servers and a related secured communication system, supporting these needs for secure and safe communication through the open cellular and internet communication, enabling a secure data exchange and management, through a dedicated secured communication ecosystem that is geared for serving the BYOD data employee and employer daily work related under a safe and secured data exchange management and maintenance supporting system.

### BACKGROUND OF THE INVENTION

Bring your own device (BYOD), also called bring your own technology (BYOT), or bring your own phone (BYOP), and bring your own PC (BYOPC)—all refer to the policy of permitting employees to bring personally owned mobile devices (modern Smartphones, laptops and tablets) to their workplace, and to use those devices to access privileged employer company (Enterprise) information and applications. The phenomenon is commonly referred to as IT consumerization. The term is also used to describe the same practice applied to students using personally owned devices in education settings. BYOD is making especially in the years after 2010 a very significant acceptance in the business and enterprise IT management world, with about 75% of employees implementation in high growth markets such as Brazil and Russia and 44% in developed markets already using their own technology at work. Surveys have indicated that businesses are unable to stop employees from bringing their personal mobile devices into the workplace. Research is divided on its related benefits, with some reports indicating productivity gains by employees. Companies like “Workspot” believe that BYOD may help employees be more productive. Others say it increases employee morale and convenience by using their own devices and makes the company look like a flexible and attractive employer. Many feel that BYOD can even be the preferred means to attract new hires, pointing to a survey that indicates 44% of job seekers view an organization more positively if it supports their device. With around 95% of employees stating they use at least one personal device for work, BYOD has in the recent year developed to the state that company IT and security managers simply cannot ignore.

The term BYOD first entered common use in 2009, courtesy of Intel when it recognized an increasing tendency among its employees to bring their own devices (i.e., Smartphones, tablets and laptop computers) to work and connect them to the corporate network. However, it took until early 2011 before the term achieved any real prominence when IT services provider Unisys and software vendor Citrix Systems started to share their perceptions of this emergent trend. BYOD has been characterized as a feature of the “consumer enterprise” in which enterprises blend with consumers. This is a role reversal in that businesses used to be the driving force behind consumer technology innovations and trends. In 2012, the U.S.A Equal Employment Opportunity Commission adopted a BYOD policy, but many employees continued to use their government-issued Blackberries because of concerns about billing and the lack of alternative comparatively secured devices. In August 2014, a California court ruled that companies must reimburse any work calls done on any employee's personal phone in the state (Labor Code section 2802).

The proliferation of devices such as Smartphones and tablets, which are now being most commonly used by many people in their daily lives, has led to a number of companies, such as IBM, to allow employees to bring their own devices to work, due to perceived productivity gains and cost savings. The idea was initially rejected by IT managers due to security concerns but more and more companies are now looking to incorporate BYOD policies, with over 90% of respondents to a BYOD survey saying in 2014 that they either already supported BYOD or were at least considering supporting it.

Although the ability to allow staff to work at anytime from anywhere and on any device provides real business benefits; it also brings significant risks. To ensure information does not end up in the wrong hands, it is imperative for companies that want to implement the BYOD policy with their employees to integrate security measures into the BYOD related solutions. Various risks arise from BYOD, and agencies such as the UK Fraud Advisory Panel encouraged organizations to consider and solve these issues before and adopting a BYOD policy.

BYOD security relates strongly to the end node problem, wherein a privately owned mobile device is used to get access to both sensitive and risky networks/service risk-averse employers' organizations. BYOD can easily result in enterprises' data security breaches. For example, if an employee uses a smartphone to access the company network and then loses that phone, untrusted parties could retrieve any unsecured data on the phone. Another type of security breach occurs when an employee leaves the company, they do not have to give back the personal privately owned device, so company applications and other data may still be present on their device. Furthermore people sometimes sell their devices and might forget to wipe sensitive information before selling the device or handing it down to a family member, such as a child for instance. Various members of the family often share certain devices such as tablets; a child may play games on his/her parent's tablet and accidentally share sensitive content via email or through other popular data storage and sharing means such as Dropbox.

From the privacy of the private mobile owner point of use, IT management and enterprise security departments of the employer that wish to monitor usage of personal devices must ensure that they only monitor work related activities or activities that accesses company data or information, without breaching the employee/worker own data privacy. Organizations who wish to adopt a BYOD policy must also consider how they will ensure that the devices which connect to the organization's network infrastructure, to access sensitive information, will be protected from Malware.

Traditionally when the device was owned by the organization, the organization would be able to dictate for what purposes the device may be used, or what public sites may be accessed from the device. Under a BYOD policy an organization can typically expect users to use their own devices to connect to the Internet from various private or public locations. The BYOD users could be susceptible from attacks originating from un-tethered browsing, or could potentially access less secure or compromised sites that may contain harmful material that might compromise the security of the device and later affect and damage the enterprise resources.

Software developers and device manufacturers constantly release security patches due to daily increase in the number of threats from malware. IT departments that support organizations with a BYOD policy must be therefore prepared to have the necessary security management solutions, systems and processes in place that will apply the patches to protect systems against the known vulnerabilities to the various devices that users may choose to use. Ideally such departments should have agile systems that can quickly adopt the support necessary for new devices. Supporting a broad range of devices obviously carries a large administrative overhead. Organizations without a BYOD policy have the benefit of selecting a small number of devices to support, while organizations with a BYOD policy could also limit the number of supported devices, but this could defeat the objective of allowing users the complete freedom to completely choose their device of preference. Several market and policies have emerged to address BYOD security concerns, including mobile device management (MDM), containerization and app virtualization.

While MDM provides organizations with the ability to control applications and content on the employee private mobile device, research has revealed controversy related to employee privacy and usability issues that lead to resistance in some organizations. Corporate liability issues have also emerged when businesses wipe devices after employees leave the organization.

A key issue of BYOD which is often overlooked is BYOD's phone number problem, which raises the question of the ownership of the phone number. The issue becomes apparent when employees in sales or other customer-facing roles leave the company and take their phone number with them. Customers calling the number will then potentially be calling competitors which can lead to loss of business for BYOD enterprises.

Recent International research reveals that only 20% of employees have agreed and signed a BYOD policy. It is more difficult for the firm to manage and control the consumer technologies and make sure they serve the needs of the business. Firms need an efficient inventory management system that keeps track of which devices employees are using, where the device is located, whether it is being used, and what software it is equipped with. If sensitive, classified, or criminal data lands on a U.S. government employee's device, the device is subject to confiscation. A challenging but important task for companies who utilize BYOD is to develop a policy that defines exactly what sensitive company information needs to be protected and which employees should have access to this information, and then to educate all employees on this policy.

Another important issue with BYOD is of scalability and capability. Many organizations today lack proper network infrastructure to handle the large traffic which will be generated when employees will start using different devices at the same time. Nowadays, employees use mobile devices as their primary devices and they demand performance which they are accustomed to. Earlier Smartphones did not use a lot of data and it was easy for Wireless LAN to handle that amount of data, but today Smartphones can access web pages as quickly as most PCs do and have applications that use radio and voice at high bandwidths, hence increasing demand from WLAN infrastructure.

In today's mobile world, employees are tech savvy and want more of a say about the tools that they use to get their work done, and rightfully so. Employees who use their preferred devices under a BYOD related IT system configuration have seen not only an increase in job satisfaction, but also an increase in overall productivity. Most organizations tend to implement and choose a BYOD strategy, but fall victim to the many pitfalls associated with it.

Some industries are adopting BYOD quicker than others. A recent study by Cisco partners of BYOD practices, stated that the education industry has the highest percentage of people using BYOD for work at 95.25%. A study by IBM says that 82% of employees think that Smartphones play a critical role in business. The study also shows benefits of BYOD include increased productivity, employee satisfaction, and cost savings for the company. Increased productivity comes from a user being more comfortable with their personal device; being an expert user makes navigating the device easier, increasing productivity. Additionally, personal devices are often more cutting edge as company technology refreshes don't happen as often. Employee satisfaction, or job satisfaction, occurs with BYOD by allowing the user to use the device they have selected as their own rather than one selected by the employer IT team. It also allows them to carry one device as opposed to one for work and one for personal. Cost savings can occur on the company end because they now would not be responsible for furnishing the employee with a device. A company can also see improved productivity from an employee with BYOD since the device may easily be moved between home and work.

Portable wireless communication equipment, including smart mobile telephones, (Smartphones) portable data assistants (PDAs), Notepads, Notebooks and other mobile electronic devices have been widely expanding in their popular use and are available and their technical and operational capabilities are fast expanding in the recent years. They are frequently used for implementing various daily needs through dedicated applications by the computer age users. Never the less It has also been recognized that the high portability, strong computing power and the fast expanding daily frequent use of modern portable wireless communication equipment, is not any more just serving as a conventional phone or data communication device, but their use is expanding for using as modern communication devices as well as computerized mobile workstations.

These computerized features are now serving most of modern user's life and under the BYOD also work related management needs. More specifically, because such devices are carried by most modern users through most of daily and night time activities hours, they are most suitable to be used as the user's safe and secured personal data depository including the user's personal and sensitive medical data depository. Further, a loss or theft of such devices creates a risk of unauthorized access and possible mal use of the device's internal user's personal data depository, the loss of a costly smartphone personal device containing a large variety of personal information important to its user, may lead to unauthorized access and mal-use by a hostile intruder to sensitive user's data stored on the device.

To reduce the risks of unauthorized use of the device's communication services and/or unauthorized access to stored data, most portable communication devices include a password or a PIN number protection system. A typical password protection system is implemented by disabling the keypad, or the telephone circuits, and/or the specific installed data application, unless and until the user enters an applicable unlock code. Generally the password/unlock code is in the form of alpha numeric text which may be entered using the keypad of the mobile electronic device.

There exist several challenges with such alphanumeric password/unlock code protection systems. First, the protection provided by a password only exists so long as the password is not compromised. Many people tend to use passwords that are easily guessed, or write their passwords on paper, and otherwise compromise the integrity of their passwords. Second, user entry of a password (and the associated key strokes needed to reach the password entry prompt and active the electronic device after password entry) can be hard to recall and also time consuming and aggravating—to the point where many people select the option of disabling the password protection of the mobile electronic device and their content.

An alternative system used to password protect a mobile telephone is disclosed in U.S. Pat. No. 6,351,634 to Shin. The system of Shin is useful for a mobile telephone that includes a touch screen. A registered secret symbol is used as the password. The secret symbol comprises a stroke number value responsive to the existence of pressure applied to the touch screen and X/Y coordinate values for each stroke. In operation, a user inputs a symbol using the pressure sensitive touch screen to draw the various strokes of the secret symbol. The device determines whether the input symbol matches the registered secret symbol and unlocks the telephone if the character stroke number value and the X/Y coordinate value signals match that of the secret password symbol. Shin teaches that the secret password symbol can be a character, a signature, a numeral, or a combination thereof. A significant challenge of the system of Shin is that so long as someone can duplicate the secret password symbol, whether by tracing the user's code insertion acts or by careful drawing possible variations on the touch screen, such person has access to the mobile telephone. Stated another way, authentication of the user is based on the user being able to duplicate the strokes and shape of the secret password symbol.

The aim of a biometric system or mobile integrated module is the realization of the identification/authentication of people using some biological characteristic or physically measured behavior of the individual, in a safe and non-invasive way. The problem of identification and authentication of people is very old and has always tried in the past to be solved with different media: seals, titles, stamps, nameplates, etc. Today this is not enough and you need to introduce new legitimate user authentication and identification techniques to ensure that a person is who they say they are in many contexts.

There are many biometric techniques that try to recognize a person by their physical characteristics (iris, face morphology, fingerprint, voice recognition, etc.) or their behavior (gait, air gesture, manner of writing, online signature, etc.). It is vital in this document, by its similarity, to implement signature by a biometric technique online. Many works have been developed to improve this technique. They explain the basis for online signature verification. In this type of biometric identification testing, it is compared while the user is drawing on the screen to be matching to the one stored, and that the way to make such signature matches to what was done and recorded in the initial registration procedure by the registered user. To this end, various parameters are measured when making a signature, such as writing speed, pressure or angle of the pen at each point in time when the signature is done, among other features. These signatures may be performed in a special screen that collects and analyzes all necessary signals for analysis or on paper if the pen with which the firm is able to measure the signals described above and send them to a server where you perform the analysis and the signature verification.

Patent No: MX2007007539 describes a system implementing the biometric authentication using an electronic signature. This system includes an interface to a computer capable of storing the movement of a cursor on a computer screen and compared with already stored signature patterns.

The first object of the present invention relates to performing a highly reliable and unique user's authentication capability in a mobile device. Today, there are many applications, especially while aiming at the BYOD related applications of the user communicating with his employer enterprise IT resources that may be accessed from a mobile terminal, where it is necessary and even critical in many implementations to positively and reliably identify the legitimate user. For years the entrusted all security user's identification on mobile devices are based on a simple solution, that is to type a secret key (PIN) on the phone keypad that the user knew. However, these keys can be easily forgotten, transferred, lost or even counterfeit, so that user authentication is highly compromised. Focusing on the advanced and more secured biometric technique to authenticate a user with a mobile device is found in US2006286969 and in US2008005575.

Patent No: US2006286969 describes a remote authentication scheme to authenticate users from a mobile device. The biometric technique used is the voice recognition. The system consists of a mobile phone to send voice samples of an authentication device that connects to a database that stores the identities of mobile phones and voice pattern associated with that phone to make a comparison and check the user is talking on the phone is registered in the system. Patent No: US2008005575 proposes a method and integrated personal electronic device for authenticating a user on a mobile phone. While the user holds the phone to his ear, a microphone emits a signal near the user's ear and the speaker phone is able to measure the ear's response to this signal. A processor analyzes the response signal and converts it into a signature that uniquely identifies each person and can be used to authenticate.

Alternatively various bio-authentication techniques are known as gesture recognition, in which a system is able to detect when a user makes a certain known gesture. Patent Nos: US2009103780 and WO2009006173 relate to methods to recognize standard gestures. Patent No: US2009103780 includes a method for collecting the gestures produced by hand, based on light hand at first by the palm and the back, to get your silhouette associated from various lighting infrared, it proposes a method for collecting various hand movements and identifying a series of gestures previously stored in a database of gestures.

Patent No: WO2009006173 describes a method for detecting the response of an electronically gesture of a user while listening to a speaker using a mobile device, when performing a specific gesture. Related to the idea of recognition of a person by making a gesture is found in patent WO2007134433. It develops a method to authenticate a user when performing an action that manual manipulation of a device such as a mouse. Authentication is to obtain the gesture with the mouse by the user when chasing a target and compare it to the stored pattern of the user when that objective has been pursued previously.

Regarding the use of accelerometers in mobile devices, Patent No: US2005226468 describes authentication systems proposed to authenticate the user based on certain biometric sensors must be connected to the mobile device, and verifies that the authentication was successful based on a accelerometer that collects data on how to get the user's device, ensuring it is not a machine trying to cheat the system.

Also, Patent No: US2009030350 discloses a method and a system for analyzing patterns gaits of a subject by measuring the acceleration of the head in the vertical direction while walking. It uses an accelerometer that is placed on the user's head. The analysis includes the creation of a signature from the acceleration data when a user walks. In another invention the prior art also proposes the use of the patterns obtained by realizing the user gesture for generation or release of a cryptographic key, as described in Patent Nos: DE102005010698 and KR749380-B1. DE102005010698 describes the construction of a cryptographic key for secure communication independent from the fingerprint. It proposes to use that key to communication demand TV with pay per view applications, child protection or age verification.

KR749380-B1 describes a method to generate a key from a biometric characteristic that does not change with time as the iris. The biometric information is received and preprocessed, extracted some values and associated cryptographic key is obtained by grouping the values. The clustering error is corrected using a block of Reed-Solomon code. The obtained key may be applied to any cryptographic system.

Consequently, it is desirable to have a highly reliable mobile platform geared for best and highly secured BYOD use, that will be securely highly protected enabling safe access to the user's employer's Enterprise IT resources. Secured BYOD operation is enabled through a device integrated biometric recognition and authentication module, as will be further described in the present invention. The invention solution should avoid the drawbacks existing in the presently known BYOD use and management methods, and related mobile devices and systems, representing the present state of the art. The present invention solution should perform a biometric authentication process, which brings and combines the two general characteristics of biometric authentication: the physical characteristics and behavior.

Recently there is a new trend surfacing that may start to replace BYOD in the coming years. Corporately Owned, Personally Enabled (COPE) devices are the next big thing that within the coming years, some projections indicate 70 percent of global organizations will adopt it. BYOD is a concept that was floated first in Asia, where CIOs were quick to embrace the trend, but also recently realize it's hard to manage implications, such as: challenges in securing corporate data, an increased need for IT resources and support, increased costs, difficulty maintaining network performance, and challenges in managing a high multiple plurality of different user chosen devices and related required applications. Companies like BlackBerry, which was ahead of the curve in adopting BYOD, were also the first to try out COPE projects pilots, where the goal was essentially to show customers this model was a better, less risk-laden option for enterprise mobility than was BYOD.

The biggest difference between BYOD and COPE is the management of personal data on the device. Employees own their devices with BYOD, hence Bring Your Own, which gives organizations less control over how they are being used. It goes without saying that this leads to massive potential for security issues. It also puts an organization in peril, especially with the cases of sales force owning their own phone numbers. With COPE, the end user has more flexibility in choosing a mobile out of an employer offered reasonable selection, but the organization still has better and reasonable control over standardization, costs, security, and other areas of potential risk such as legal and HR implications. For example, corporations can dictate what carrier the organization uses and what devices can sit on the network but may, for example, allow users to indicate what apps they want on their phone and offer employees a device catalog to select from. This gives employees personalization options, while also minimizing the need for employer's IT to manage an overwhelmingly mixed range of devices. COPE also gives organizations the power to monitor policies and devices, beyond simply selecting which ones can be distributed. If the device is stolen, the company can send a wipe command. Organizations can also conduct automatic checks on malware and dangerous applications, sending warnings about certain apps to the device owner in order to proactively avoid potential issues.

When helping enterprise IT managers to migrate to COPE, a number of ways were found to aid organizations in further maximizing the benefits. One advantage is the ability to recycle devices as part of the contract. Alternatively, to keep costs down, buy communication devices in bulk. By doing so, enterprise can negotiate substantial discounts. To take that one step further, beyond minimizing just the device costs, outsourcing enterprise mobility contracts also enables organizations to make the best use of resources and budgets. Enterprise can negotiate usage-based plans, for example, to minimize unnecessary spend. Understand the benchmarks from cost benefits, usage statistics, and device performance. Benchmarking is important act when making a transition in the enterprise mobility model, as it provides a measureable way to evaluate costs, usage, and performance. Moreover, it enables executives within the organization to see the tangible benefits of a COPE model by clearly indicating the improvements in productivity, efficiency, and overall business execution from a numbers perspective. There are more hidden costs associated with BYOD than with COPE; costs to look out and get data to include device management and maintenance, personal service partitioning and impacts, and migration expenses, among other things. Due to dramatic improvement in device software upgrades, it's vital to ensure the internal systems are able to work with the latest software versions. This can have a bearing on how well COPE adoption can take place without substantial hidden migration costs. While COPE enables organizations to better control corporate assets over information, as well as tangible control, it also boosts employee satisfaction. This, in turn, results in a surge in employee productivity (evident from the days of BlackBerry) due to the shortening of decision support. So while today BYOD continues to dominate enterprise mobility discussions, COPE is phasing it out, as more organizations realize the benefits and flexibility that can be achieved though the COPE alternative model.

Therefore there is also a need in the art for enterprise employee users to have an easy to use and more secured mobile communication device that includes modules and methods for enabling high reliability, better security and ease of use of an integrated new way of authenticating of a legitimate user of the mobile device, and locking or unlocking its BYOD/COPE enterprise resources related communication and internal secured data access functions and the device's stored enterprise user's work related sensitive data, storage and access capabilities, in a case of negative or a positive user authentication. The need is for a secure BYOD/COPE solution that also does not suffer from the disadvantages of implementing present art traditional characters strings based password protection solutions and of other heavy security oriented data encapsulation installed BYOD/COPE separation SW solutions limiting the mobile communication device to much slower and reduced performance disadvantages of present art SW based BYOD/COPE adapted mobile devices and the related supported systems.

Regarding to terminology used in this document portable communication equipment, also referred to herein as a “mobile radio terminal”, includes all equipment such as mobile phones, pagers, communicators, Notepads Notebooks and alike, e.g., electronic organizers, personal digital assistants (PDAs), smart phones or the like. It should also be appreciated that many of the elements discussed in this specification, whether referred to as a “system” a “module” a “circuit” or similar, may be implemented in hardware (circuits), or a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

### SUMMARY OF THE INVENTION

The following embodiments and aspects thereof are described and illustrated in conjunction with devices, methods and systems, which are meant to be exemplary and illustrative, not limiting in scope. In various embodiments, one or more of the above-described limitations and emerging modern user's growing mobile devices daily secured use needs, have been solved, reduced or eliminated, while other embodiments are directed to other advantageous or improvements of securely managing a modern user personal and private medical data depository.

The core of the present invention is an advanced and highly reliable new approach to have and manage an enterprise employee user's work related data through an isolated secured platform to be used in conjunction and in tandem with the mobile communication device of the employee for separately and securely running and managing organization's applications/programs, as well as enabling and fully supporting the user's remote enterprise IT resources secured access and data exchange and storage of the sensitive organization data. The present invention device is an attachable smart electronic mechanically packaged sleeve shaped mobile device add-on case for attaching securely to the user's mobile phone, wherein the present invention add-on mobile device contains a CPU, SD flash based memory card, battery, a plurality of biometric sensors and wired digital data communication means to exchange data with the user mobile phone. Optional are the invention electronic sleeve internal independent power supply battery and a NFC and/or Bluetooth short distance wireless communication modules. With the invention device the users are authenticated for content entry permission by using advanced biometric identification techniques and algorithms. In addition, the invention electronic sleeve includes Near Field Communication (NFC) and/or Bluetooth communication means, which can be used also as personal bio-identification wireless key device for fully supporting user's biometric authentication requirement to enable highly secure physical access control needs.

The Invention is also supporting the user's BYOD related management needs on the user's dedicated data isolated smart computerized modular electronic device. The electronic device, designed as an add-on sleeve, is attached to the user mobile phone or palm device and securely interconnects and exchanges data through the user's personal mobile data communication integrated modern, residing on the users mobile device, which enables communication through the cellular and internet communication infrastructure with the external remotely situated employer IT resources. The invention also deals in particular with highly secured mobile communication servers based system, securely connecting and managing the users' devices two-way communication with their employer's IT resources.

The enterprise world is going through major changes related to the advancement of mobile devices—becoming Smartphone, Tablets or the upcoming wearable devices. The popularity of those devices and their use for many personal applications if fast growing and expanding while their increase capabilities may lead for enterprise as well as for the employees to use personal mobile device as access point to the enterprise computer servers and IT resources. The ability of using the smart mobile as an enhancing of user's productivity tool, made it also the replacement for the desktop and note-book for many professionals employees being able to run their business activities out of office, while travelling, or at home. “Bring Your Own Device” (BYOD) is a major trend in the enterprise IT infrastructure.

The BYOD concept smart-mobile being used by enterprise employees, both for personal use and organizational use is a major security headache and high expenses management burden for IT and network security officers in enterprise organizations. The existing security solutions on the employee's mobile phone must keep a balance between security and the user's usability. This balance leads to security compromises which might affect the entire enterprise network security. The present invention device and its related based communication system with the user's employer enterprise, is offering a new solution approach based on a separate and highly secured data storage and communication management mobile phone add-on sleeve device. The new Sleeve enables also secured communication and secured email features, securely managing sensitive emails between the user and work related emails coming through the enterprise email servers.

It provides for the enterprise sensitive data management requirements the required physically hardware based protected area not available yet even in the newer Smartphones and operating systems security. The invention combined communication phone and secured data management attached sleeve is creating a fully managed and secured integrated new device having its own encryption capabilities, protected keys and secure operating system. The invention combined device provides the protection required for sensitive documents storage and management, and securely managing valuable corporate IP and commercial data assets. The invention combined device and related invention enhanced BYOD related combined hardware and SW based system are also capable for protecting employee's email account as well as running enterprise applications in a protected environment.

The present invention advanced user authentication biometry makes sure that only authorized users should be able to have access to the secured data. The present invention combined secured communication device and system is planned to be part of the organization IT or IT service provider's secured network, while keeping the users private mobile free for the user's daily normal use without any restrictions.

Enterprise proprietary and sensitive data depository storage on the present inventions dedicated mobile devices there is a need to highly protecting the invention mobile device stored medical data depository against intruders, hackers and mal use. The invention device has an integrated highly reliable authentication module, analyzing the user's at least one biometric sensors measure output when user's authentication is done while the user is holding the mobile device and operating in tandem the biometric sensors measurement on his relevant human body parts and on monitoring his unique human behavior parameters.

One of the main objects of the present invention proposes the creation of a positive and highly reliable and secured user's authentication by implementing an advanced fusion by advanced algorithm through a dedicated computer SW embedded within the invention electronic sleeve device that is processing the measured outputs of at least one biological sensors and measuring their output in tandem as the user's more reliable combined authentication means.

Two of the preferred embodiments of the present invention biometric identification and authentication means and methods may be the user's face recognition and by imaging and analyzing the image of the user's hand palm and fingers morphological pattern, in another novel embodiment of the present invention the image of the palm may include also the veins and minor blood vessels seen on the palm surface image while imaging the palm with an IR sensitive camera sensor and illuminating the palm with an near IR illumination source such as a high intensity IR LED. Other mean may be by a human movement or gesture pattern while the mobile device is intentionally moved in the air while held in the user's hand in a personalized movement pattern that identifies a user, taking into account that this gesture will only be known by the user and also that physical characteristics, it will perform differently to other people who might try to repeat the gesture. Focusing on technical status related to the present invention, it should be noted that performing gestures to biometrically authenticate a person on a mobile device using 3D in-air gestures measured with an accelerometer is novel.

A first aspect of the present invention comprises a mobile electronic device which enables a user to authenticate himself through the parallel in tandem operation of the present invention mobile electronic device internal integrated set of at least one or more biological sensors capabilities and then to enable a function of the mobile electronic device using its internal CPU module to differentiate between the authenticated legitimate user and a none authenticated none legitimate user by analyzing and detecting the user's personal unique biometric sensors output measurement such as the user's face pattern image, the user palm and fingers image analysis and the user's personalized movement sequence, while 3D moving the mobile electronic device in the air.

The mobile electronic device comprises a 3D acceleration measurement module generating an acceleration signal representing the user hand motion in space while holding and uplifting the mobile electronic device. A lock/unlock circuit enables operation of at least one function of the mobile electronic device in response to the measured 3D acceleration signal indicating that the user holding the mobile device hand motion pattern deviates from pre-recorded reference original owners hand motion uplifting movement signal data, while holding and uplifting the mobile device by more than a predetermined threshold.

The lock/unlock circuit may further comprise an integration module and an executable authentication process module. The integration module integrates the acceleration signal with respect to time to generate a velocity signal and a displacement signal. The executable authentication process: i) compare a representation of the displacement signal and the velocity signal, with or without the acceleration-measured signal, to the reference motion data. The reference motion data comprising reference displace; and ii) enables operation of at least one function of the mobile electronic device if the representation of the displacement signal and the velocity signal and the acceleration signal data deviate from the reference displacement data and velocity data and the measured acceleration data by more than a predetermined threshold. The reference motion data may also represents the device legitimate user's simple three dimensional gesture movements in space and the user motion represents the device user moving the electronic device in the same simple three-dimensional gesture.

One preferred embodiment of the present invention enhanced BYOD system supports a user's remote work required interaction functions with the employer enterprise management system. The system is combined of a plurality of remotely distributed employees owned identified users' controlled integrated mobile personal devices, each said personal device containing a secured Enterprise user's work related management data module, each said integrated mobile personal device constructed of a combined mobile communication device together with an attached mobile electronic sleeve device, said sleeve functioning as a private user bio-authentication and enterprise secured data communication and related work records files storage and management platform, the system comprising: a. a system gateway server operating as said system manager for managing and updating communication addressing ID data of said system plurality of remote BYOD work management employee users private mobile devices and for securely communication between each of said plurality of said BYOD remote work employees mobile devices with their employer enterprise IT resources; b. a memory sub-system connected to said system gateway server to store updated ID data of said mobile devices and any required associated user data of each of said plurality of said mobile devices users; c. a plurality of personal mobile devices units, each of said mobile devices being associated with a unique user, each unique ID data of said mobile devices being registered with said system gateway server and wherein the ID data file of each unique ID data of said mobile devices being stored in said memory sub-system; d. wherein said gateway server enables access and creates a communication link with the any of said system registered BYOD work management employee users through their said private mobile devices containing said user's work related management data and documentation files; and e. wherein said access to any user's requested said device stored work related data and documentation files and two way data communication with said user remote employer enterprise IT data resources is only enabled after positive authentication of said unique user's enabled by said user mobile personal mobile device.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a schematic visual illustration of a schematic 3D layout of the typical present art BYOD system comprised of multiple employee users computerized devices, both mobile and stationary computerized devices, connected through security management envelops with the enterprise core internal IT management network.

FIG. 2 is an illustration of a schematic block diagram of one possible embodiment of the present invention mobile personal electronic device configuration, wherein it has combined configuration comprising the invention electronic sleeve shape add-on device that includes a microprocessor module, a large storage capacity Flash memory, a user authentication module, an acceleration detectors module, a tilt detectors module, an audio microphone module, two cameras and related image processing module, It also demonstrates the attached second present invention device combining mobile communication device that includes the invention personal electronic device implemented and used display and touch screen interaction module and an RF cellular communication module and a GPS location module.

FIG. 3 is a schematic illustration of the present invention integrated mobile personal electronic device combined of the user mobile device and the invention electronic sleeve. The figure demonstrates the functional modules residing on each of the two present inventions integrated device components.

FIG. 4 is a schematic illustration of an example of a computerized enhanced BYOD management system, according to one embodiment the present invention system.

The schematic illustration shows another preferred embodiment the main functional modules of the user's invention integrated mobile personal electronic device combined of the user mobile device and the invention electronic sleeve. This device is connecting through the cellular and internet managed cloud to the user employer IT management infrastructure.

FIG. 5 is a schematic illustration of one possible embodiment of the present invention process of the Personal Information Management (PIM) functioning of the employee's user invention integrated mobile personal electronic device with the employer enterprise server.

FIG. 6 is a schematic illustration of one possible embodiment of the present invention process of the Content Management process functioning structure of the user invention integrated mobile personal electronic device while functioning interaction elements with the enterprise server.

FIG. 7 is a schematic illustration of one possible embodiment of the present invention process of the Application Management interaction functioning elements of the user invention integrated mobile personal electronic device with the enterprise server.

### DETAILED DESCRIPTION OF THE INVENTION

The present invention, in some embodiments thereof, relates to mobile devices user's enhanced BYOD applications and use related solutions and, more particularly, but not exclusively, to methods, a device and a system to manage and conduct mobile devices bio authentication and enhanced BYOD performance related communication execution between the employee users and the employer enterprise resources.

Before explaining some embodiments of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a device, a system, and a method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, integrated personal electronic device, or device, or any suitable combination of the foregoing. More specific examples (a non-exhaustive list) of the computer readable storage medium would include the following: an electrical connection having one or more wires, a hard disk, a random access solid state memory (RAM), a read-only memory (ROM), an erasable programmable read-only memory (EPROM or Flash Memory), an optical fiber, an optical storage device, a magnetic storage device, or any suitable combination of the foregoing. In the context of this document, a computer readable storage medium may be any tangible medium that can contain, or store a program for use by or in connection with an instruction execution system, integrated personal electronic device, or device.

A computer readable signal medium may include a propagated data signal with computer readable program code embodied therein, for example, in baseband or as part of a carrier wave. Such a propagated signal may take any of a variety of forms, including, but not limited to electronic, electro-magnetic, optical, or any suitable combination thereof. A computer readable signal medium may be any computer readable medium that is not a computer readable storage medium and that can communicate, propagate, or transport a program for use by or in connection with an instruction execution system, integrated personal electronic device, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package on the user electronic sleeve shaped add-on computerized device, partly on the user's smartphone and partly on a remote computer, or entirely on the remote computer or server. In the latter scenario, the remote computer may be connected to the user's mobile device through any type of network, or the connection may be made to an external computer (for example, through the Internet using an Internet Service Provider, or through a cellular service provider).

Aspects of the present invention are described below with reference to flowchart illustrations and/or block diagrams of devices, methods, systems and computer program products according to different embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a smartphone, on an electronic sleeve shaped smartphone add-on computerized device, a notepad, a laptop, a special purpose computer, or other programmable data processing integrated personal electronic device to produce a machine, such that the instructions, which execute via the processor of the computer or other programmable data processing integrated personal electronic device, create means for implementing the functions/acts specified in the flowchart and/or block diagram block or blocks.

These computer program instructions may also be stored in a computer readable medium that can direct a computer, other programmable data processing integrated personal electronic device, or other devices to function in a particular manner, such that the instructions stored in the computer readable medium produce an article of manufacture including instructions which implement the function/act specified in the flowchart and/or block diagram block or blocks.

The computer program instructions may also be loaded onto a smartphone a mobile or portable computerized device, other programmable data processing integrated personal electronic device, or other devices to cause a series of operational steps to be performed on the computer, other programmable integrated personal electronic device or other devices to produce a computer implemented process such that the instructions which execute on the computer or other programmable integrated personal electronic device provide processes for implementing the functions/acts specified in the flowchart and/or block diagram block or blocks.

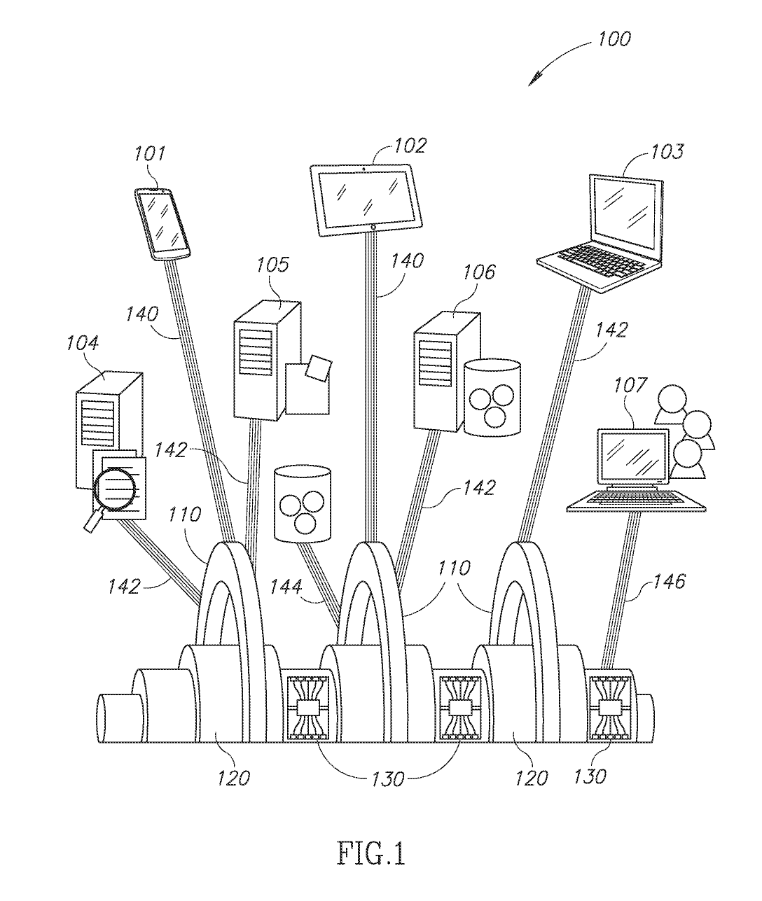

Reference is now made to FIG. 1, which is an illustration of an visual illustration of a schematic 3D layout of the typical present art BYOD system 100 comprised of a multiple employee users mobile devices and computerized devices, representing both three typical types of mobile devices, smartphone, note-pad and laptop 101, 102, 103 and various types of stationary computerized PC devices 104, 105, 106, 107, all connected through security management envelops 110 with the enterprise security access protection layer 120 and through it to the enterprise IT management core 130, that is including the enterprise internal servers and IT management system and also including internal data communication network and the related data flow.

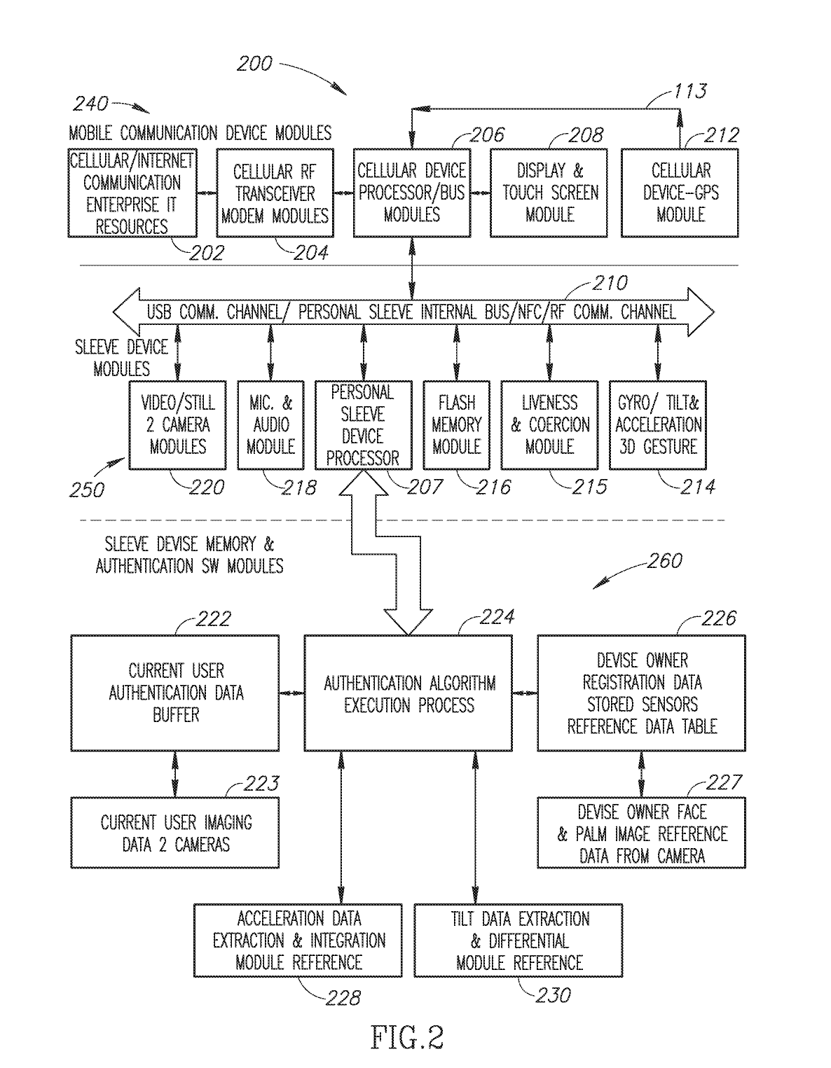

Reference is now made to FIG. 2, which is an illustration of an example of a computerized mobile electronic device hardware and software content and related modules combined configuration, according to the present invention. The Invention Mobile personal electronic device 200 is combined of 240 which is a representation of an exemplary present art mobile personal electronic device 240 (smartphone) geared for serving as a single user BYOD secured and safe communication means with the User Employer enterprise servers and computerized resources. The second invention attached add-on device 250 is serving the user/employee as a personal data storage, updating and management tool with a built-in user's bio authentication capabilities, based on at least two device's integrated biometric sensors output analysis of the user device holding person, done while the user holding in his palm the invention integrated personal mobile electronic device 200. The present invention integrated mobile device 200 is communicating through the cellular and internet communicating networks with a the user employer enterprise IT resources 202 through the cellular wireless networks, as required to operate some of the dedicated functions related to the present invention mobile personal electronic device user's enhanced BYOD remote work related management functions. The invention integrated mobile device Cellular RF transceiver and Modem module 204 is representing the mobile device module that supports and enables the device cellular and internet supported data communication with the remote Enterprise IT resources 202. The mobile communication device processor 206 is controlling the entire mobile communication device with various functions of communication, display and user's flat screen 208 graphic management and processing capabilities. The invention electronic add-on sleeve 250 processor 207 is managing the sampling and the processing of the device movement sensors 214 output data and the imaging 220 and 218 voice sensors, as required to support the execution of user's authentication program module 224. The Authentication analysis and execution module 224 operation is based on the user gesture movements analyzed against the reference enrollment stage recorded and stored reference data 228 and 230 and in parallel, or by the user selected sensor alternative, also compared with the face and palm recorded reference image data 227, compared with the user's face and palm real time sampled images recognition measure data 223 and the user's voice processing 218 sampled data. The display module 208 is a combination of a graphic/image display screen and a touch sensitive screen to support the user's various interactions and the display of the user's touch screen interactions results with the mobile personal electronic device 200 executed for the user through the mobile communication device 240. The electronic sleeve shaped electronic add-on device central internal data communication bus 210 is communicating between the mobile device and the invention sleeve device through the device 250 integrated USB hardware interface and through a NFC, Bluetooth or other RF based wireless short distance communication channel, combining together the described communication channel 210 operating within the add-on sleeve device 250. 210 supports the needs to transfer data and commands between the various modules of the invention integrated personal mobile device 200—combined of mobile device 240 and the invention mobile add-on sleeve 250. Module 220 is the mobile device add-on sleeve which has a resident internal still/video imaging module 220 including one or preferably two or more electronic camera units, equipped with aided LED visible and near infrared active illumination that support the imaging of the device user face and/or palm, in order to document and authenticate the user according to his face and/or palm & fingers details pattern according to some embodiments of the present invention. Audio module 218 is including at least one microphone that enables the voice identification of the user as one of the selected biometric sensors required for the potential execution option of the user's authentication, based on the user voice personal characteristics analysis. Flash memory module 216 is at least one or more modules of solid state flash based memory modules (optionally a SD card) resident within the electronic sleeve shaped add-on device 250 that holds the operational software of the sleeve shaped add-on device 250, as well as the device 250 functional software modules 222, 224 and 226 that support the invention integrated mobile device 200 requirements to function as an isolated BYOD management secured communication and storage devise of the employee/user and serving also as a secured data personal depository of the device 200 single owner user/employee to hold in memory 216 also sensitive work related encrypted data files. Liveness and Coercion related measurement and results analysis module 215 is serving as a measurement sensor to detect and measure several liveness parameters of the invention device holder and based on these measurement to decide if the device 200 holder is a live person not a fake image and also defining if he is under a substantial emotional pressure, or is in a normal state of mind. Tilt and acceleration 3D sensors module 214 is a unit resident within the invention integrated mobile device 200 with the electronic sleeve add-on sleeve device 250 that measures the linear acceleration on the three orthogonal axis of the device and the 3D tilt angles of the sleeve device 250 in space. GPS module 212 is another important built-in sensor, resident within the present invention mobile communication device 240, wherein the GPS 212 world coordinated device dynamic poisoning reading is fed through communication channel 213 to cellular device processor module 206 so to enable the allocation of the device in case of an employee not in his natural work place during work time or in case of the user problematic medical situation emergency cases or for supervising of the employee not natural expected location during work hours when is required to be detected and monitored by the user/employee employer.

Authentication data buffer module 222 which is a part of the electronic add-on sleeve device 250 memory and authentication sub-section 260, is a secured memory buffer containing the device biometric sensors sampled data of the mobile personal electronic device user's authentication reference data, as the stored digital converted output of the various sampled mobile electronic sleeve shaped device 250 resident biometric sensors, wherein the biometric data is collected and stored during the user first and initial enrollment registration process. The data buffer module 222 is also connected with sub-module 223 that samples and stores at registration/enrollment the current user face and palm images digitized reference data, to further use it as the user's additional channels of bio authentication sources, according to the one or more of the present invention authentication embodiments. Module 224 is the central SW module in the present invention electronic sleeve device 250 managing the selection of optimal process for selection, choosing and executing the optimal residing authentication algorithm, choosing the optimized one of several authentication algorithms and significant user identification sensors selectable sources options. The 224 module does the analysis the user's biometric sensors 220, 218, 230 and 227 modules output. The 224 module also creates the improved quality and reliability of the authentication process of the integrated mobile electronic device 200 while fusing together the user's measured biometric sensors output, wherein the method is implementing into the authentication process the user hand in air 3D gesture, the user's face pattern and the palm recognition imaging data, as the first, the second and the third selectable sources of the user's bio personal data, thus enabling an optimal quality authentication process, combining gesture, face and palm personal bio data.

Module 224 has in one of the invention embodiment another function with an additional set of SW based group of functions 260 designed for execution in the cases that the authentication process of the current device holder is indicating a failure which is a non-authenticated user case. In such a case the module 224 is creating a series of preprogrammed alarm functions, optionally creating audio alarm set of signals on the audio module 218 and displaying visual eye attracting flashing images through the display module 208. In parallel alarm data is sent from the invention mobile device to a remote cellular service provider and through it to a set of the users who are the device owner group of pre-selected piers to notify them on the event of theft or loss of said device 200 and the location of the theft, as it is constantly read and transmitted by the GPS module 212. Software module 226 is storing and managing legitimate user reference registration data, as required by present invention integrated mobile personal device 200, while managing the registration procedure of the legitimate user prepared and stored by module 226 to serve as the reference set of data while compared to the current user biologic sensors measured and processed authentication data. A sub module connected, functioning with and used by module 226. SW module 227 stores and manages the legitimate device owner face data including its face recognition parameters and also stores and manages the registered user's piers (friends and family) face recognition data to avoid false operation of the device alarm functions when one of the legitimate user's piers is by mistake lifting and holding the invention theft and loss protected mobile device. Module 228 is a SW module that manages the extraction of the sampled output of a set of sensors and also in processing integration algorithms on the acceleration measured device results data in order to achieve data related to the device velocity and position in space, based on the acceleration data one time and two times integration calculation results, Module 230 is a SW module that manages the extraction of the sampled gyro based tilt measurement 3D set of sensors and also in processing derivatives algorithms on the tilt angles measured device data results, in order to achieve data related to the device angular velocity and angular acceleration in space, based on the measured 3D tilt angles data, one time and two times derivatives calculation results,

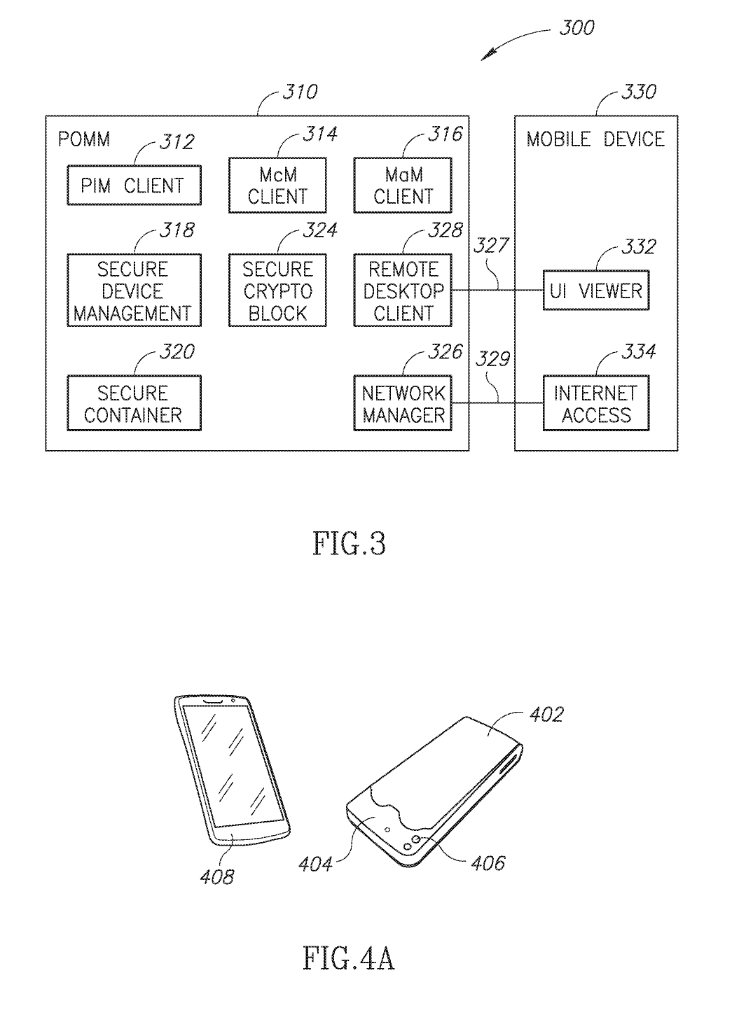

Reference is now made to FIG. 3, which is a schematic functional blocks representation illustration of the present invention integrated mobile personal electronic device 300 combined of the user mobile device 330 and the invention electronic add-on sleeve 310. The figure demonstrates the functional modules residing on each of the two present invention integrated device and its module components 310 and 330.

The electronic sleeve add-on device 310 Secure Device Management module 318, located in the invention electronic sleeve add-on device 310 is responsible to communicate with enterprise MDM Server component on the enterprise network and perform the required function. The electronic sleeve add-on device 310 management functions include: 1) online monitoring of the MDM server of all MDM clients for currently connected devices 300, 2) Enforcing remote wipe of locking for compromised devices and 3) Logging of user action on the electronic sleeve add-on device 310 by the McM client 314 and sending periodic reports to MDM server at the enterprise remote side.

The invention electronic sleeve 310 devices interact with the mobile device 330 with two channels 327 and 329: 1. Remote desktop client module 328 is interacting with the mobile device 330 UI Viewer 332 through UI Channel 327; and 2. Network channel 329 is interacting between the module Network Manager 326 residing on the invention sleeve device 310 and the Internet Access module 334, residing on the Mobile device 330. In the UI channel 328 the mobile is acting as a remote viewer 332 to the invention electronic sleeve 310, enabling the user to interact with invention electronic sleeve 310 through the UI Remote Desktop Client module 328. Through the network channel 329 the mobile 330 is acting as a cellular modem and internet access gate 334 to the invention electronic sleeve 310, enabling network communication with the corporate/enterprise servers.

FIG. 3 represents the high-level modules in the invention electronic sleeve 310 devices for supporting these management functions. The present invention enhanced BYOD system supports enterprise mobility management in four categories operated through dedicated module on the invention sleeve devise 310:
Device Management (MDM), 318
Personal Information Management (PIM), 312
Content Management (McM), 314
Application Management (MaM), 316.

The functionality derived from each of these categories require client components on the invention add-on electronic sleeve device 310, as well as server components on the enterprise network to communicate with these clients. The Client-Server components are:
Enterprise MDM Server—Secure Device Management client. 318, on sleeve 310
Enterprise PIM Server—PIM Client, 312 on sleeve 310
Enterprise MaM Server—MaM Client, 316 on sleeve 310
Enterprise MCM Server—MCM Client, 314, on sleeve 310

In addition to these components in the invention electronic sleeve 310 device based system, it include also a Enrollment server for registering the invention electronic sleeve 310 devices to the enterprise system for identification purposes

The Following FIGS. 5, 6 and 7 describe the invention enhanced BYOD related system processes, needed to support the four enterprise mobility categories.

In the invention device 300 Enrollment Process, this is a process in which the enterprise system is registering the invention device in order to identify the access request from the invention device. This process is done by Enrolment Server which includes all necessary invention device private and public keys.

The enrollment is done by connecting the invention device 300 physically to the Server with USB connector. The enrollment process includes key provisioning for the invention device 300, as well as biometric enrollment of the employee.

The invention add-on sleeve device within the 310 Secure Device Management module 318 located in the invention device 300 is responsible to communicate with MDM Server component on the enterprise network and perform the required function. The Device 310 management functions, includes:
Online monitoring of the MDM.
Enforcing remote wipe of locking for compromised devices.
Logging of user action on the invention device 300 by the MDM client 318 and sending periodic reports to MDM server.

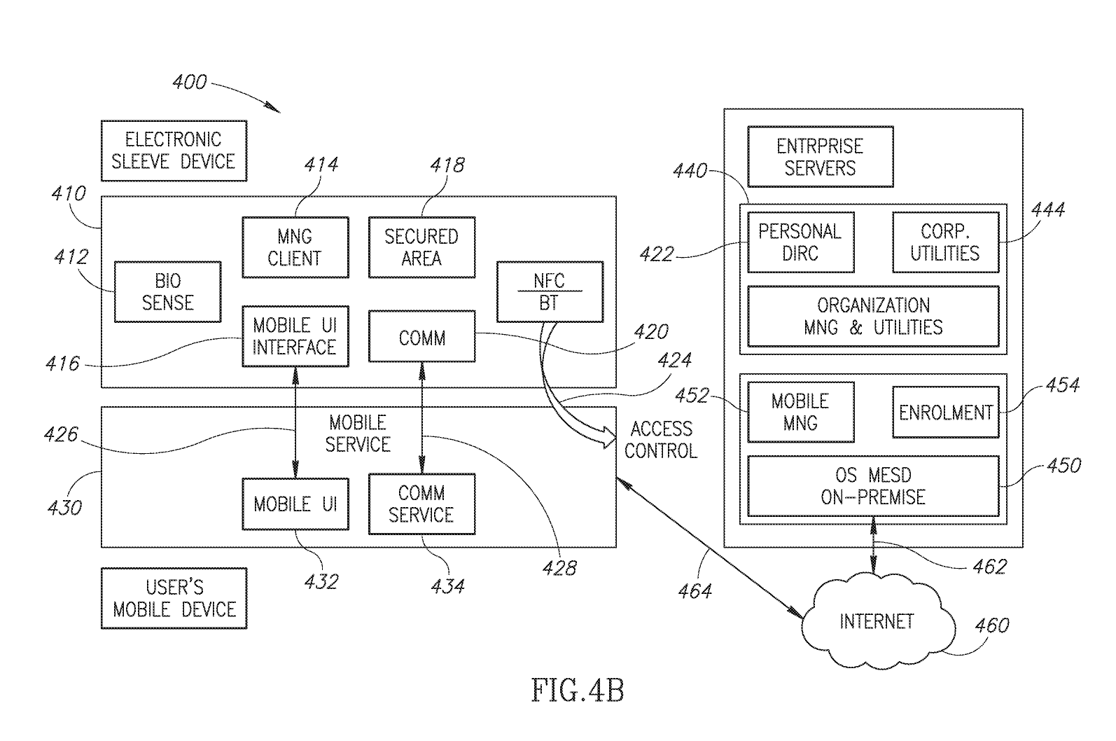

Reference is now made to FIG. 4, which is an illustration of an example of a computerized enhanced BYOD management system 400, according to one embodiment the present invention system.

In FIG. 4A, a schematic physical view illustration shows another preferred embodiment of the invention mobile device 200 main functional modules 404 and 402, combining these physically connected two functional modules, thus creating together the user's invention integrated mobile personal BYOD use oriented electronic device 200, combined of the user mobile device 402 and the invention electronic add-on sleeve 404, wherein the mobile device 402 is fitted and locked inside a dedicated recess in the electronic sleeve 404, where a USB connector installed at the end of the 404 recess is electronically connecting the two modules for a data exchange requirements and for power charging both devices through the USB connector at the external lower side of the 404 sleeve. 406 is illustrating the front aperture of one of the two imaging cameras integrated within the add-on sleeve 404. 408 show the invention add-on sleeve without the mobile phone inserted in it. This combined device 404+402 is connecting through the cellular and internet managed cloud to the user employer IT management infrastructure.

FIG. 4B is a functional schematic illustration of the invention combined mobile device dedicated to BYOD functioning communicating with the Employer dedicated servers and SW modules managing the secure communication between the employees BYOD adjusted devices and the employer IT resources. It shows the add-on sleeve device 410 that is including the user's authentication oriented bio-sensing module 412, and the device client data processing and management module 414 based on the internal integrated powerful CPU. Secured area 418 includes a security protected area for storage in employee sleeve device 410 of sensitive files of the user employer enterprise proprietary data. Communication unit 420 includes hardware based USB communication capability 428, as well as a NFC and/or Bluetooth short distance communication capability 426 to transfer secured data files between the mobile device 430 and the present invention add-on electronic sleeve device 410, physically attached as a binding sleeve to the user smartphone unit. The sleeve device 410 has also a built-in NFC/BT output unit 424 that enables it to connect from short distances with kiosks, ATMs or PCs that enable device 410 to upload and download data from external terminals.

The invention new BYOD oriented device is including in it a mobile device 430 that includes in it a SW communication management sub-unit 432 that creates and is in charge of the wireless communication 464 through the cellular networks and the Internet infrastructure 460 between the BYOD mobile device 430 and the connected invention electronic sleeve 410 and the Employer remote IT resources 450 and 440 through its internet communication link 460.

The invention BYOD mobile device 430 is connecting through link 464, based on its integral cellular communication modem and communication SW based means 434, to the internet 460, supporting internet/cloud communication for the long distances that are typically required for the remote user/employee hand held communication device to connect to the IT infrastructure supported by the employer IT resources multiple servers manager 440. Remote Enterprise BYOD application management 440 requires supporting servers included in units 450 and 440. To let the enterprise servers to recognize and further accept the legitimate enterprise worker/user personal device, the employers servers are first conducting for every new remotely detected user/employee, an enrollment procedure, so there is also at the Employer IT management side a detected employee BYOD device first access enrollment to be processed through enrolment management server 454. A Mobile Management Server at the Employer IT resources side 452 is in charge of the secure data communication management with all the remote multiple employees BYOD devices 410+430. Enterprise servers unit 440 Organization Management and Utilities includes in it also the personal directory server 442 that is managing the remote user's data base and the secure data flow and transfer between the multiple remote users using their personal BYOD 410+430 devices and the enterprise IT resources. Corporate utilities server 444 manages a plurality of remote access services to the remote BYOD users, such as electronic mail and secure access to employees-corporate directories 442 and internal enterprise management resources 444.

Reference is now made to FIG. 5, which is a schematic block diagram illustration 500 of one possible embodiment of the present invention system BYOD functions management SW modules and its configuration and the related secure communication process of the Personal Information Management (PIM) SW module 502 residing on the user/employee BYOD device functioning the controlled execution of the employee's user integrated mobile personal electronic device 410+430 communication with the employer enterprise dedicate MESD On Premise servers unit 450.

It also demonstrates the user's communication through the VPN 504 SW management module with the enrollment server management module 506 for the user first time initial registration procedure into the enterprise system BYOD processes control servers; the Access Control 510, the POMM PIM Server 512 and the Enterprise Active directory server 516.

The invention device 410+430 POMM PIM Client SW module 502 specific user/owner employee enrollment process is a process in which the enterprise system is registering the invention device 410+430 in order to identify the legitimate access request from the invention device 410+430. This process is done by Enrolment Server 506 which includes all necessary invention device 410+430 private and public security management keys. The enrollment is done by connecting the invention device 410+430 to the Server 506 through a VPN data link. The enrollment process includes key provisioning for the specific user/employee invention device 410+430, as well as the biometric enrollment of the employee.

In the PIM operational mode, the invention device 410+430 through its integrated POMM PIM Client SW module 502 can view and interact with the enterprise Personal Information Directory 516, functioning such as an Active Director and enabling the remote employee user to receive corporate emails and view his personal work related missions and meetings calendar. The Process of accessing the personal directory is starting with creating a VPN 504 connection through the firewall 508 to the Access Control Server 510 of the enterprise. After the invention device (410+430) integrated POMM PIM Client 502 is assigned an internal IP, the invention device PIM client 506 can communicate with the invention device PIM Server 512 through the Employer IT integrated Firewall protection module 508 and the Access Control Server 510 and then securely interact through this server using the MAPI supported internal Employer IT resources capabilities 514 with the active directory executed through the Exchange Server 516.

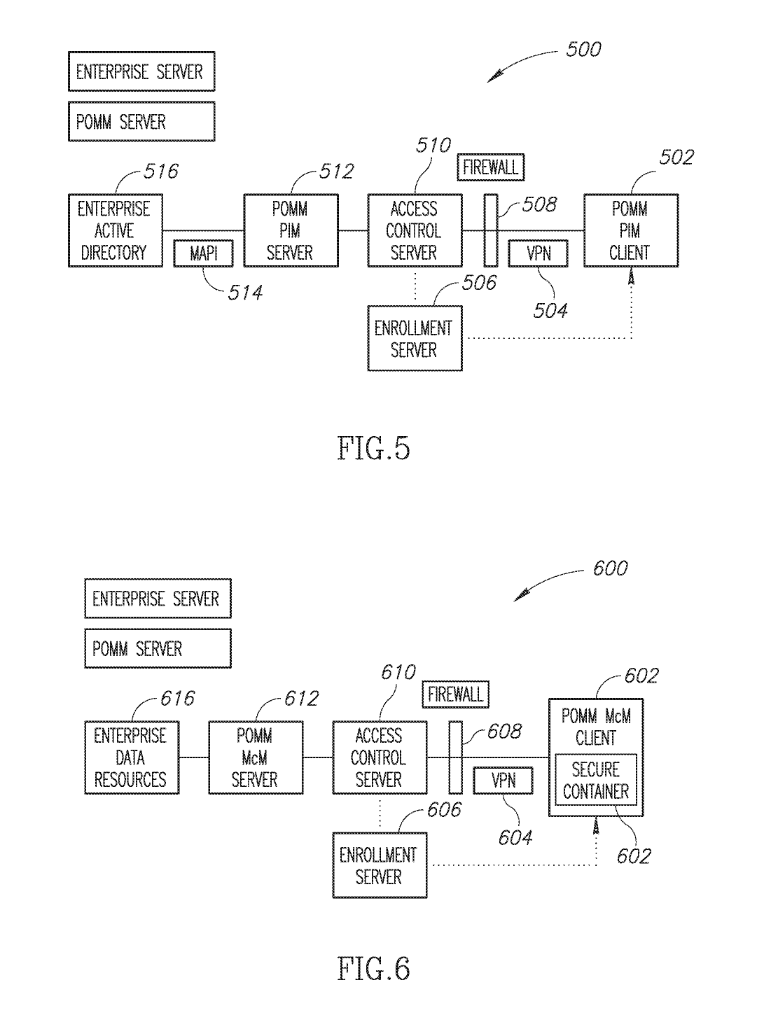

Reference is now made to FIG. 6, which is a schematic block diagram illustration 600 of one possible embodiment of the present invention process of the Content Management process functions of the user invention integrated mobile personal electronic device 602 while functioning its interaction elements with the enterprise Access Control Server 610 and the POMM McM Server 612.

In Content Management operational mode the invention device client 602 must enforce policies like copy/paste restriction on top of the Secure Storage Container 603.

The process of content management begins with VPN 604 connections to the Access Control Server 610 through the Firewall protection layer 608. Then the McM Client 602 can access through the Access Control Server 610 to the McM Server 612 and navigate through this server 612 for reaching and accessing the Employee work required corporate data resources 616. Once the requested data is found, the McM Server 612 binds the data with security policy, which is enforced by the McM Client 602. The McM Client 602 is the only device residing module that allows dealing with corporate data in the invention device. The McM Client 602 also stores the data locally in a secure container 603 that is inside the invention device 410+430 client 602.

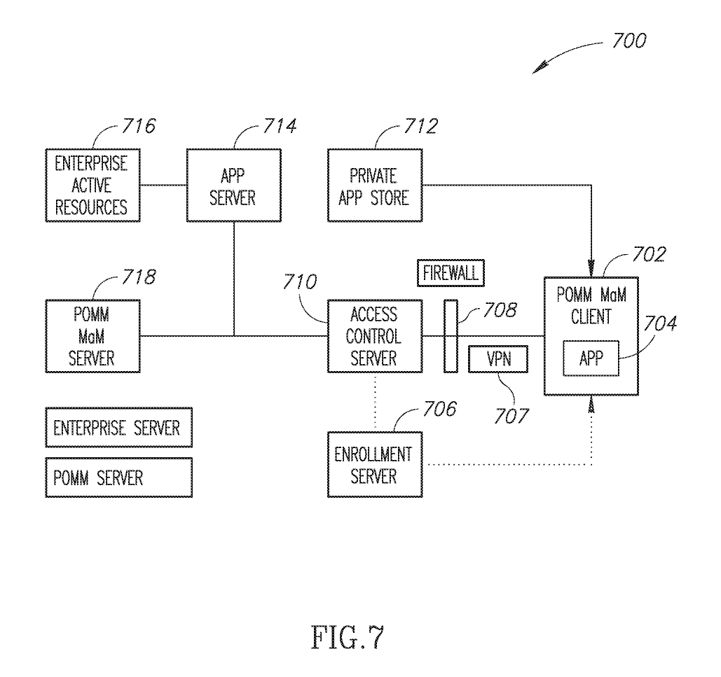

Reference is now made to FIG. 7, which is a schematic block diagram illustration of one possible embodiment of the present invention BYOD functioning related management process of the Application Management interaction between the POMM server and the Enterprise Server 700, while functioning the data management elements between the user invention integrated mobile personal electronic device 410+430 and its POMM MaM Client 702 with the enterprise Access Control server 710, the App management server 714 and the POMM MaM Server 718.

In Application Management operational mode the enterprise application are running on the invention device and the device integrated MaM client 702 that is controlling the lifecycle of the application and security policies. The process begins with the invention device 410+430 POMM MaM Client 702 downloads through Firewall protection layer 708 and Access Control Sever 710 data streaming through the application server 714 from the corporate private data resources store 716. In Some cases due to the BYOD use dual purpose employee's communication life management strategy, the POMM MaM client 702 can also download required Application for a specific non-work related task from its connected Private App store 712. The MaM client 702 when in a work related mode is then communicating with the MaM server 718 for policies of the application and the corporate data 716 it needs to access. The MaM client 702 is also responsible for communicating with the private app store 712 in case that specific data content update or removal is needed.

It will be appreciated that the present invention is not limited by what has been described hereinabove and that numerous modifications, all of which fall within the scope of the present invention, exist.

Rather the scope of the invention is defined by the claims, which follow:

What is claimed is:

1. An integrated mobile personal electronic device securely communicating, managing and updating in parallel all user's BYOD related remote work tasks and in parallel seperately supporting the user's private life daily operations, comprising:
a. a mobile communication device equipped with a cellular modem to enable data communication over the cellular and internet networks equipped to receive and send both user's employer enterprise work related data as well private data with a plurality of sources.
b. an electronic sleeve shaped add-on device, attached and fits to said mobile communication device external back side perimeter, to create together with said communication device a unified user carried single device, said sleeve contains at least a CPU, a solid state large capacity secured memory module equipped to seperately store and manage said user's work and personal data, a RAM unit and an at least one biometric sensors module;
c. wherein; said biometric sensors module comprised of a set of at least one biometric measuring parameter sensor, each of said at least one sensors is measuring and generating a different user's characterizing biometric parameter;
d. said electronic sleeve contains a software module that activates a set of functions for enabling secured access and communication between said sleeve containing secured enterprise work related data with a plurality of operational functions of said user work related tasks residing at said user remote employer enterprise IT resources; and
e. wherein in response to said biometric sensors module measured and sampled signal sequence, followed by receiving a positive user's authentication analysis results by said sleeve CPU, all executed on said at least one user's measured biologic sensors output signals processing results, then said electronic sleeve activating and creating direct two-way secured data communication channel through said communication device cellular modem between said user and said user remote work enterprise IT resources.

2. The integrated mobile personal electronic device of claim 1, wherein:
a. said set of BYOD user's work related functions activation and operation is executed when a user sampled biometric data sequence of said user measured at least two biometric parameters are compared by said sleeve CPU to similar prerecorded and stored on said sleeve memory set of sampled device reference biometric measured data;
b. wherein said prerecorded sampled biometric reference data is recorded upon the legitimate user executing on said mobile electronic device an initial supervisor controlled registration procedure, enabled by said at least one biometric sensors output being recorded and securely stored on said electronic sleeve memory for further user's system entry need authentications;
c. wherein said BYOD related set of user's work functions is positively activated and said device sleeve secured memory is unlocked and ready for use, only for a pre-defined time duration when said electronic sleeve operated by a legitimate mobile device user is activating said at least one measured user's biometric sensors and said at least new sensor output data is being positively compared with said legitimate user pre-recorded registration procedure reference data, and said two sets of sensors' output data deviates from each other by less than a predetermined minimal threshold; and
d. wherein said mobile personal electronic device further containing a touch screen display unit for display of data to the user and indicating said device status and for the user's interaction with data content of said mobile electronic device communicating with said user remote work enterprise IT resources.

3. The integrated mobile personal electronic device according to claim 1,
wherein at least one of said at least one biometric sensors is a life signs detector, said life signs detector being configured to measure and record at least one of said user's life sign parameters to indicate it is a real live legitimate user.

4. The integrated mobile personal electronic device of claim 1,
wherein said at least two measuring biological sensors are selected from the sensors group including at least: a three dimensional device air-gesture linear acceleration based measuring sensor, a three dimensional mobile device air-gesture angular movement tilt measuring sensor; a face recognition imaging sensor, a palm pattern and morphology and palm veins IR imaged veins networks combined measuring and analysis IR/visible imaging sensor, user's voice analysis based on a voice pickup microphone sensor and at least one user's life signs indicating physiological parameters measuring sensor.

5. The integrated mobile personal electronic device of claim 2,
wherein the digital output of one of said biometric sensors user's biological parameter measurement results and said second measured at least one additional biometric sensor output results, are fused together by using a learning and adaptable dynamically weighted factor fusion algorithm, done between said two sensors measured output, made in order to enable improved and precise analysis; and
wherein identification of the legitimate user exact typical personal characteristics under said algorithm is creating a highly reliable user's authentication mechanism to best decide if to authenticate the present interacting user, while comparing to a similar reference prerecorded fused set of said two kinds of sampled user's biometric sensors, if to activate said internal sleeve operation for enabling user's access through said secured device with said user work remote enterprise IT resources, or to enable the internal operation of one or more user BYOD work related interaction functions with said user BYOD adapted mobile electronic device.

6. The integrated mobile personal electronic device of claim 2,
wherein said mobile device further comprises a biometric data processing module for processing the output of said first and a second biometric sensors; and wherein said mobile device further comprising a database management software module to manage the user work enterprise records stored in said mobile device sleeve solid state large capacity secured memory, said work related data records are database managed to enable said device user quick and easy filing and retrieval of specific work enterprise data records files.

7. The integrated mobile personal electronic device of claim 2, further comprising;
a. a dedicated encryption module within said electronic sleeve, said encryption module resides within said sleeve CPU secured zone and is used to encrypt and decrypt said data content of said user work enterprise data records stored encrypted in said mobile device sleeve; and
b. wherein the encrypted data of said at least one biometric sensors pre-recorded registration procedure reference generated data is being recorded and stored for further authentications as the biometric sensors registered user authentication reference data.

8. The integrated mobile personal electronic device according to claim 1,
wherein said at least one of biometric sensors output is continuously reading and producing a plurality of personal biological identification associated output parameters associated with said user holding the integrated personal electronic device; and
in the event that a noticeable change occurs in any of said measured personal biological identification parameters, then access to said stored user work enterprise data files is denied and the operation of said electronic sleeve device is completely shut down while the operation of said mobile communication device is still intact.

9. The integrated mobile personal electronic device according to claim 3,
wherein said at least one of said user's life sign parameters is measured by one or more sensors selected from the group of life sign indicators and sensors, including; a heart bit rate measurement indicator, a blood O₂ saturation level indicator, a body heat measurement indicator, an electro-dermal activity indicator, a body respiration indicator and a physical or emotional stress coercion sensing measurement indicator.

10. The integrated mobile personal electronic device according to claim 9,
wherein, whenever any of its at least one life sign indicators detects a pre-defined critical level, said mobile electronic device is configured to initiate an emergency call to at least one entity selected from a group of the user's work enterprise memory stored emergency management units, or remote emergency medical centers and then said mobile electronic device sending a group of data files containing emergency case management information associated with the user, including the personal identification data file of the user, personal emergency situation related medical data file of said user, the recently measured set of life sign parameters of said mobile electronic device user and the location of the user.

11. A method for employee user remotely interacting, managing and updating data and associated documentation exchange for enabling user's BYOD related remote work with said user employer enterprise resources, said user having an integrated mobile personal electronic device including mobile communication means and an electronic sleeve shape add-on device uniquely associated with its said single user, each of said integrated personal mobile electronic devices comprising:
a. a mobile communication device equipped with a touch screen for user's interaction and a cellular modem to enable data communication over the cellular and internet networks equipped to receive and send user's BYOD related data to and from the user employer enterprise IT management resources; and
b. an electronic sleeve shaped as an add-on device, attached and fits to said mobile communication device external back side perimeter to create together with said communication device a unified user-carried single compact device, wherein said electronic sleeve contains:
a biometric sensors module comprising at least one biometric set of sensors;
a processing CPU module in communication with said sensor module;
an authentication unit in communication with said CPU based processing module;
an encryption module in communication with said processing module;
a memory module in communication with said processing module and said encryption module; and
communication and data connection means in communication with said mobile communication device.
the method comprising the steps of:
i. said electronic sleeve biometric sensor module reading said at least one personal biological identification sensors output parameters of a user holding said mobile communication device;
ii. said electronic sleeve biometric sensor authentication module comparing the generated personal biological identification parameters of said user with a pre-recorded set of personal biological identification parameters stored in said electronic sleeve authentication unit; and
iii. if said authentication unit positively identifies said user, then allowing said user to get access to said user's BYOD related data documentation and work files stored in said electronic sleeve memory module and allowing user during said user pre defined access allowance time duration to communicate and exchange files and data with the user employer remote IT requested or needed resources through said mobile electronic device communication capabilities.

12. The method of claim 11 further comprising the steps of:
said at least one biometric sensors continuously reading said at least one personal biological identification parameters of said user while holding said mobile personal electronic device; and
in the event that a change occurs in any one of the measured at least one personal biological identification parameters, denying user access to said sleeve stored BYOD work related data files and completely shutting down said electronic sleeve internal secured memory stored BYOD work related data access and data exchange operational capability of said user with said remote employer enterprise IT resources of said user.

13. The method of claim 11, wherein at least one of at least two biometric sensors is a life signs detector, configured to measure and record at least one of a group of life sign indicators including a heart pulse rate measurement indicator, a blood O₂ saturation level indicator, a body heat measurement indicator, an electro-dermal activity indicator, a body respiration indicator and a physical or emotional stress coercion indicator, the method further comprising the steps of:
a. initiating an emergency call to at least one emergency center wherein said center details and communication data are registered and stored in said mobile device electronic sleeve memory, whenever any of the user's measured life sign indicators detects a critical abnormal level; and
b. wherein said emergency call transmits a selected medical emergency related data file of medical and personal information associated with the user, including identification of the user, personal emergency medical data file of the user, including the measured set of life sign parameters of said user and the measured location of said user.

14. The method of claim 11, wherein said integrated mobile personal electronic device further comprises an emergency button, selected from the group comprising a software generated soft button and a hardware button, said button in communication with said processing module and said communication and data connection means, the method further comprising the steps of:
a. when said emergency button is activated, communication is initiated between said mobile personal device and at least one registered emergency mobile service or emergency center; and
b. said emergency communication transmitting a emergency data file with information associated with the user, including identification of the user, the updated personal emergency medical data file of said user, and location of said user.

15. A BYOD oriented user's remote work for supporting user's—employer enterprise interaction functions management system, said system combined of a plurality of remotely distributed employees with their owned identified users' controlled integrated mobile personal devices, each said personal device containing a secured Enterprise user's work related management data module, each said integrated mobile personal device constructed of a combined mobile communication device together with an attached mobile electronic sleeve device, said sleeve functioning as a private user bio-authentication and enterprise secured data communication and related work records secure files storage and management platform, said system comprising:
a. a system gateway server operating as said system manager for managing and updating communication addressing ID data of said system plurality of remote BYOD work management employee users private mobile devices and for securely communication between each of said plurality of said BYOD remote work employees mobile devices with their employer enterprise IT resources.
b. a memory sub-system connected to said system gateway server to store updated ID data of said mobile devices and any required associated user data of each of said plurality of said mobile devices users;
c. a plurality of personal mobile devices units, each of said mobile devices being associated with a unique user, each unique ID data of said mobile devices being registered with said system gateway server and wherein the ID data file of each unique ID data of said mobile devices being stored in said memory sub-system;
d. wherein said gateway server enables access and creates a communication link with the any of said system registered BYOD work management employee users through their said private mobile devices containing said user's work related management data and documentation files; and
e. wherein said access to any user's requested said device stored work related data and documentation files and two way data communication with said user remote employer enterprise IT data resources is only enabled after positive authentication of said unique user's enabled by said user mobile personal mobile device.

16. The BYOD user's remote work related employer enterprise interaction functions management system of claim 15, wherein each of said plurality of said integrated personal mobile devices units comprises:
a. a mobile computerized communication device such as a smartphone or a notepad having an internal communication modem enabling data communication through the cellular networks and internet infrastructure and having a touch screen for user's interaction with said communication device; and
b. a mobile electronic sleeve device, said sleeve functioning as a private user bio-authentication and enterprise related work records files secured storage and management platform physically attached and electronically interconnected with said communication device, wherein said mobile electronic sleeve device further comprising;
i. a sensor module comprising a one or more of a plurality of biometric sensors for reading at least at least one personal biological identification parameters of the user holding the of personal identification unit, said personal identification unit being uniquely identified with said user;
ii. a processing module in communication with said sensor module for processing said personal biological identification parameters and for processing and managing the personal and secured data and documentation files associated with said user interactions with said work enterprise;
iii. an authentication unit in communication with the processing module configured to receive and authenticate the identity of said user by comparing said user's personal biological identification parameters read by said sensor module and processed by said processing module, with a pre-recorded set of personal biological identification parameters stored in said authentication unit;
iv. an encryption module in communication with said processing module for said encryption plus compression and/or decompression plus decryption of said user's data files;
v. a memory module in communication with said processing module and said encryption module for the storage and management of said user's work related data and documentation files; and
vi. communication and data connection means in communication with said processing module for connecting said personal mobile device units with said system gateway server and with said employer enterprise IT resources.
